(19) United States
(12) Patent Application Publication
(10) Pub. No.: US 2014/0057234 A1
(43) Pub. Date: Feb. 27, 2014

(54) DEVICE FOR TRAINING THE APPLICATION OF COMPRESSION MATERIAL

(71) Applicant: Brigitte Nink-Grebe, Giessen (DE)

(72) Inventor: Brigitte Nink-Grebe, Giessen (DE)

(73) Assignee: MEDI GMBH & CO. KG, Bayreuth (DE)

(21) Appl. No.: 14/110,256

(22) PCT Filed: Apr. 10, 2012
(86) PCT No.: PCT/EP12/56433

§ 371 Date: Nov. 5, 2013

(30) Foreign Application Priority Data
Apr. 7, 2011 (DE) DE10201106379.4

(51) Int. Cl. G09B 23/28

(52) U.S. Cl. CPC G09B 23/28
USPC 434/262

(57) ABSTRACT

The invention relates to the training and monitoring of a correct application of compression material. A training extremity (1) made of hard material is provided with multiple pressure measuring sensors (S1-S16), the sensor surface (10) of which substantially lies on the surface level (11) of the training extremity (1). A layer which is made of flexible cushioning material (12) and over which the compression material (14) is to be applied is applied over the training extremity (1) and over each sensor surface (10). A display device (4) displays the pressure values measured by the pressure measuring sensors (S1-S16) in real time.

The invention relates to a device for training the application of compression material.

In the treatment of various disorders such as e.g. lymph and vein disorders, compression treatment was found to be the most effective form of therapy. Medical practitioners, care staff and physiotherapists wind different compression materials around the body part to be treated, in particular an arm or leg of a patient. In the process, it is important for the compression material to exert pressure lying between specific boundaries onto the tissue situated therebelow. The targeted application of disposable medical bandages serves to support the interstitial tissue pressure for improved reabsorption of accumulated liquid. The effectiveness of this measure depends substantially on the applied pressure profile, wherein the pressure intensity and the spatial profile of the contact pressures are relevant to both therapy success and prevention of complications. By the application of medical compression means, local pressure is applied to the damaged tissue and vessel system, with the goal of locally supporting the interstitial tissue pressure such that the venous and lymphatic backflow is promoted. Here, contact pressure and chance in pressure under compression are decisive for the success of the therapy.

In addition to the experience of the therapist, the pressure intensity actually applied to an extremity also depends on the employed compression materials, bandaging techniques and further different mechanisms. While it is merely the contact pressure of the compression means that acts when the muscles are relaxed (rest pressure), the muscle contraction as a result of active movement leads to an increase in pressure in the interstitial tissue (work pressure), as a result of which the venous and lymphatic backflow is additionally promoted.

In order to obtain the best therapeutic result, it is necessary for a pressure profile with a controlled change in pressure, suitable for the stage, to be adapted individually to each patient. Incorrect bandaging or unsuitable compression stockings may not only have an adverse effect on the healing process but also harbor more far-reaching health risks, such as tissue necrosis or nerve damage.

Within the scope of guidelines or industrial seals of approval, specific pressure specifications have already been defined, both for compression stockings and disposable bandages. However, these published pressure specifications still differ in various European countries and there is a lack of a uniform international standard.

The current state of scientific knowledge in respect of diagnosis and therapy, for example of lymph edemas, is summarized in national German guidelines and contains differentiated general and theoretical recommendations in respect of type, scope, time period and intensity of the compression treatment. However, there is no uniform teaching or examined standard for practical application training and monitoring. Technical skills such as acquiring bandaging technique, the raising of awareness in respect of suitable bandage pretensioning for homogeneous pressure distribution predominantly result from subjective experience values and cannot be imparted from applicant to applicant due to lack of standardized teaching methods. Although the relevance of adapting a stage-suitable pressure profile with a controlled change in pressure is undisputable, measuring the pressures and changes in pressure was previously only undertaken directly on the patient.

Thus, DE 39 33 827 A1 proposes measuring the external pressure acting on tissue by pressure sensors occurring between the tissue and the area causing the external pressure. An electromechanical flexible film is proposed as sensor. The measured pressures are stored in a recording instrument and output in graphical or numerical form on a monitor.

DE 10 2007 020 247 A1 describes a device for measuring a contact pressure of a medical compression means using sensors which consist of a textile support and fluid cells with a membrane which deforms under pressure, wherein a stored fluid is present between the membrane and the pressure sensor. The fluid cells constitute an increase and therefore they also in turn influence the pressure to be measured within the meaning of a false positive pressure increase.

DE 195 05 765 C2 describes a device for measuring contact pressure of medical compression stockings and bandages using a pneumatic sensor system, which can be applied between the body part to be examined and the compression measure. The pneumatic sensor system has a pressure transducer and a closed volume, such that an air-pressure increase arising within the closed volume can be detected An inflator is used to fill the closed volume of the sensors system by linear air-volume injection. Pressure measurement signals of the sensor system are fed continuously to an electronic evaluation and display system, which determines a nonlinear calibration curve of the sensors system, which is dependent on the external pressure of the compression measure.

A problem of the known devices is that they are designed for direct application on the patient and remain on the patient for the duration of the compression measure, including their electric supply cables to the sensors, and it is unreasonable to expect this of the patient. It is also unreasonable to expect patients to be available for the purpose of training medical staff and providing practice opportunity to the latter and possibly have to endure the procedure of applying sensors and applying the compression material a number of times.

It is therefore an object of the invention to develop a device for training the application of compression material, which renders it possible to enable a simulation of the application of compression materials away from the patient which is as close to reality as possible and, in the process, obtain precise measurement values.

This object is achieved by the features specified in patent claim 1. Advantageous embodiments and developments of the invention can be gathered from the dependent claims.

The basic concept of the invention lies in the provision of a training extremity, such as e.g. an arm or leg, made of hard material, in particular plastic material, on which a multiplicity of pressure measuring sensors are applied. The sensor areas of these pressure measuring sensors lie substantially at the level of the surface of the training extremity. A flexible padding layer is applied over the training extremity and over the sensor areas. This padding layer preferably consists of synthetic nonwoven or filter materials. The sensors are electrically connected to a display device, which displays the pressure values measured by the pressure measuring sensors.

The sensor areas of the pressure measuring sensors can protrude slightly and, in particular, approximately 1 to 2 mm over the level of the hard training extremity. The padding material also guides the compression laterally onto the sensor areas, practically like body tissue. The padding material achieves a tissue-internal pressure distribution. The pressure measuring sensors are preferably designed such that they measure pressures which act perpendicular to the sensor area and also pressures which act tangentially to the sensor area, with it also being possible to detect all possible intermediate values.

A waterproof coat which can be disinfected and is disinfection means-resistant is preferably applied over the padding material; it can preferably consist of chloroprene rubber.

The metrological connections of the pressure measuring sensors are arranged in the interior of the hollow training extremity and therefore do not influence the measurement result.

The metrological connections of the pressure measuring sensors can be separated by means of sockets and plugs.

The respective pressures are preferably measured, registered and displayed on a monitor in real time. Arbitrary pressure reference values can be stored as intended pressures in an evaluation unit such as e.g. a computer. Deviations from an intended pressure value, which is defined according to position, can be displayed by signal colors, e.g. using a traffic light system with the colors red, yellow and green.

The training extremity preferably has a detachable holder, by means of which it can be attached to a stationary object such as e.g. a table. The holder has a rotatable axis by means of which the training extremity can be adjusted at least between a horizontal and a vertical position.

In the following text, the invention will, in conjunction with the drawing, be explained in more detail on the basis of an exemplary embodiment. In detail:

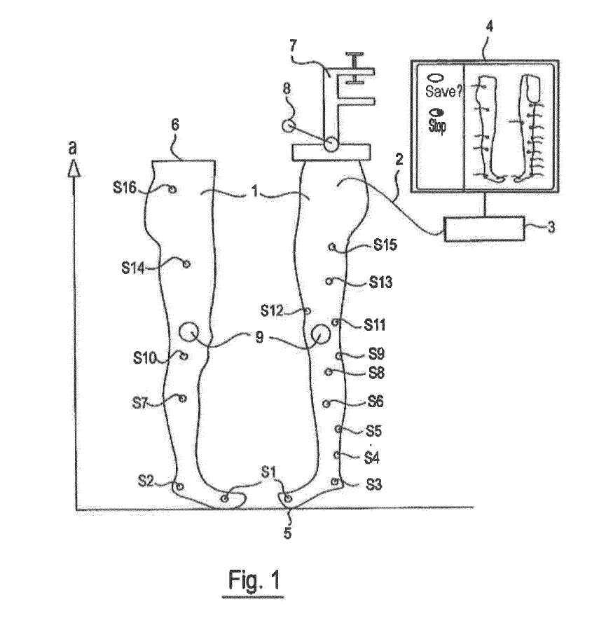

FIG. 1 shows a schematic side view of the device according to the invention;

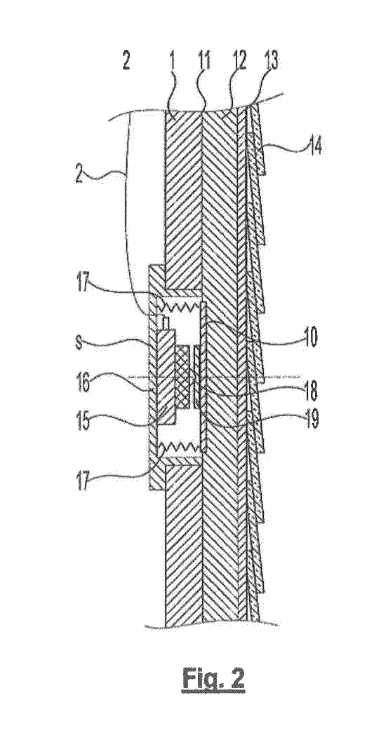

FIG. 2 shows a magnified sectional illustration of a section of the training extremity in the region of a pressure measuring sensor;

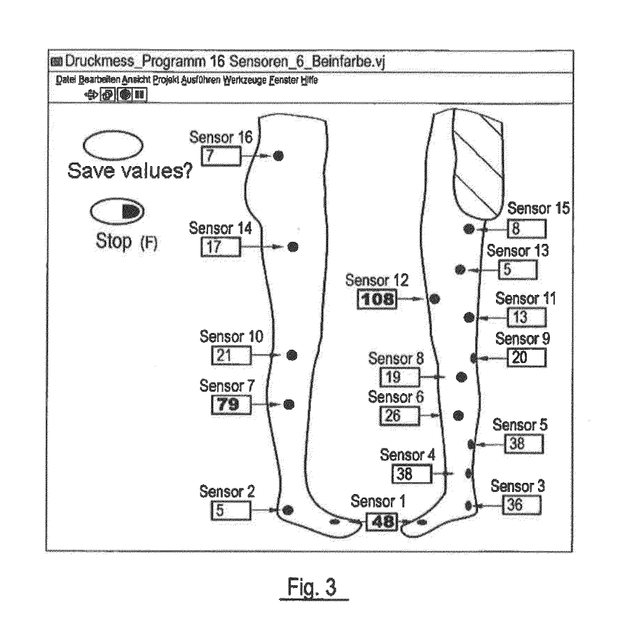

FIG. 3 shows an image of a monitor when using the device according to the invention;

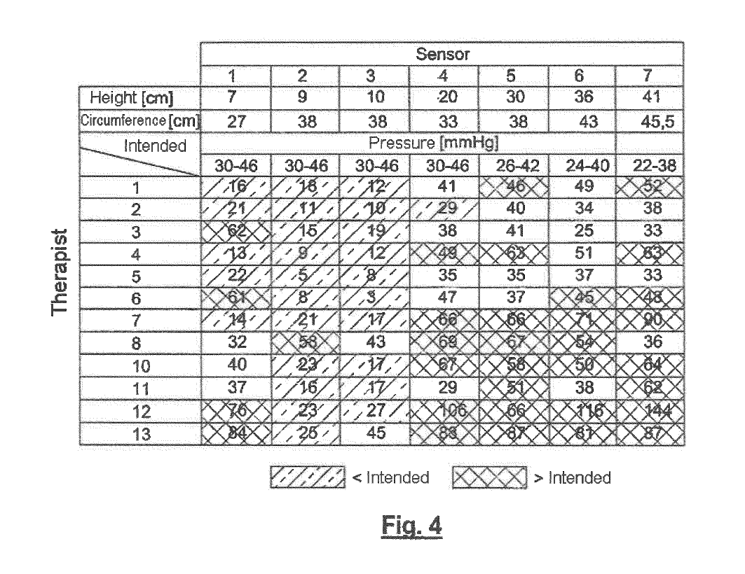

FIG. 4 shows an excerpt of a table of measurement values, which were established by different therapists using the device;

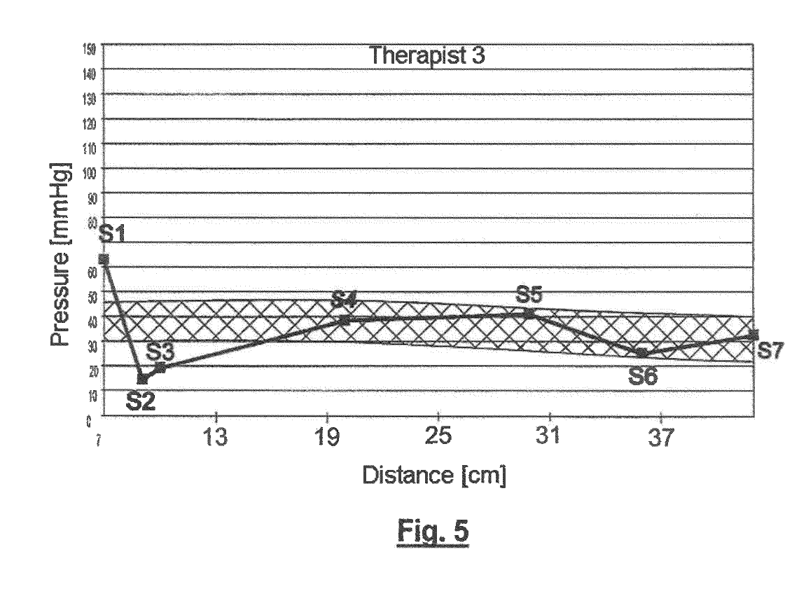

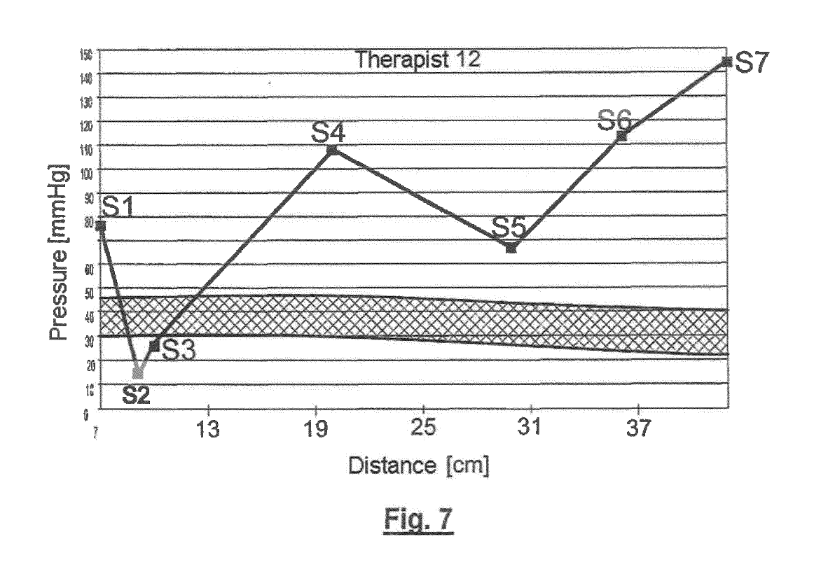

FIGS. 5-7 show diagrams of the pressure depending on the distance of the pressure measuring sensors from the distal end of the training extremity, which were established by three different therapists.

FIG. 1 schematically shows a side view of a training extremity 1. A plurality of sensors S1 to S16 are applied along the training extremity 1, the output signals of which sensors are fed to an evaluation unit, which consists of a computer 3 and a monitor 4 in this case, via an electrical line or, more generally, via metrological connections 2. The pressure measuring sensors S1 to S16 are attached to various positions of the training extremity 1, to be precise at predetermined distances a as measured from the distal end 5 in the direction of the proximal end 6 of the training extremity 1.

A holding apparatus 7 has been attached to the proximal end 6 of the training extremity and it can be used to attach the training extremity 1 to a stationary object, such as e.g. a table. The holding apparatus 7 has a pivot mechanism 8, which can be locked and by means of which the training extremity 1 can be pivoted in relation to the stationary object, such as e.g. the table (not illustrated), to be precise at least between a vertical and a horizontal position.

The training extremity 1 is depicted in two side views in FIG. 1 in order to highlight the fact that the pressure measuring sensors S1 to S16 are arranged distributed right around the circumference of the training extremity 1.

The training extremity 1 consists of hard plastic material such as e.g. polyethylene and reproduces the physiological dimensions of a human in the reproduction of an arm or a leg, it is possible to provide joints which enable a straight-line bend of the training extremity in the region of elbow or knee. In the example of FIG. 1, an appropriate joint 9 is applied at the position of a knee joint. The multiple-core line 2, which connects the sensors S1 to S16 to the computer 3, is arranged in the interior of the hollow training extremity 1. As a result, the line 2 does not impair the compression procedure and does not corrupt the measurement result either.

A section of the material of the training extremity 1 can be seen in the sectional illustration of FIG. 2. A pressure measuring sensor S is inserted into an opening in this material, the pressure measuring area 10 of which pressure measuring sensor lies substantially in a plane 11 which is defined by the surface of the training extremity in the region of the sensor S. Here, the pressure measuring area 10 can protrude slightly over this plane 11 toward the outside, to be precise in the order of 1 to 2 mm.

The whole surface of the training extremity 1 is coated by a padding material 12, which also covers the sensors S and the pressure measuring area 10 thereof. The padding material 12 is flexible and hence compressible and, as a result, simulates body tissue such as skin and subcutaneous tissue layers. In practice, it has a thickness of approximately 15 mm. By way of example, the material can be a nonwoven or filter fabric. However, other padding materials are also possible. Depending on the employed padding material, a further layer 13 of a coating can be applied to the outer surface of the padding material 12, which further coating consists of a waterproof material which can be disinfected by wiping and is resistant to disinfection means; chlorinated rubber, which is commercially available under the trade name “neoprene”, for example can be used for this. A compression bandage 14 is then applied to the respectively outermost layer 12 or 13, which compression bandage should be applied such that physiologically correct pressure is exerted. This pressure is measured by the sensors S and is reported to the computer 3 via the lines 2.

The sensors S are preferably designed using chip technology. They have a pressure/voltage transducer 15, which is arranged between a pressure measuring disk 10 and a base 16, which in this case is realized by a housing wall. That pressure measuring disk 10 and the base 16 are tensioned with respect to one another by springs 17. The pressure/voltage transducer 15 has a spherical cap-shaped sensor area 18, which engages into an adjustment disk 19, to be precise into a recess matched to the spherical cap-shaped sensor area, wherein the adjustment disk 19 is connected to the pressure measuring disk 10. By means of the springs 17, of which preferably four are provided and which all substantially apply the same force, it is possible for the pressure measuring disk 10 to tilt about the center of the spherical cap-shaped sensor area 18 and therefore also measure forces which do not occur perpendicular to the center of the pressure measuring area 10. The sensor S can also use this to measure forces which are aligned obliquely or tangentially to the plane 11. At this point, reference is made to the fact that this sensor type is preferred, but that other types of pressure measuring sensors can also be used.

The above-described sensor type is moreover described in the patent application DE 10 2010 005 792, which does not have a prior publication date.

When the compression bandage 14 is applied, the measured pressure values from the sensors S1 to S16 are displayed on the monitor 4 in real time such that the therapist immediately sees whether the compression bandage has been put on “correctly”.

As shown in FIG. 3, two views of the training extremity 1 are depicted on the monitor 4, with the sensors S1 to S16 being displayed at the correct position and with the respectively measured pressure value of the corresponding sensor. The measured values of the sensors S1 to S16 are compared to predetermined values and the displayed pressure value is illustrated in color, depending on the comparison. By way of example, pressures that are too high are depicted using the color red, pressures that are too low are depicted using the color yellow and correct pressures are depicted using the color green. The user furthermore has the option of storing the measured values in order to document training results or training successes. Hence the therapist can immediately identify the quality of his pressure application and correct and optimize this during the bandaging process.

Using the holding apparatus 7 and the pivot mechanism 8, the training extremity 1 can in each case be set such that the ergonomically most expedient position is assumed for applying the compression means. As a mobile device, the training extremity can be transported at all times for teaching and training purposes and is available as training and testing standard.

The table in FIG. 4 shows a section of measured pressure values from sensors S1 to S7 for different therapists. Twice shaded fields indicate that the measured pressure is higher than the intended value and once-shaded fields show that it is lower than an intended value range. The table, which was created with the aid of experienced therapists, dramatically highlights the fact that no therapist was able to apply a completely correct compression bandage.

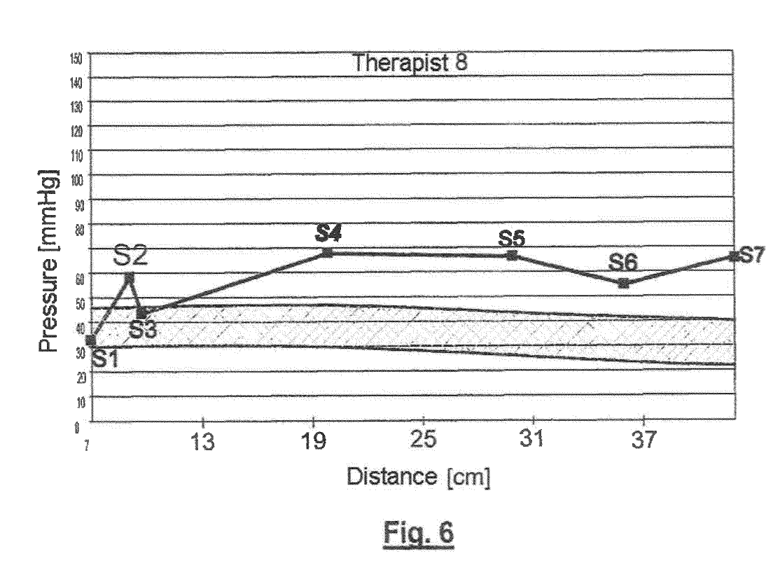

The diagrams in FIGS. 5 to 7 show the changes in pressure in a graph for three selected therapists from the table in FIG. 4, namely therapists 3, 8 and 12. The shaded region characterizes a band or an admissible value range for the intended values. The position of the individual sensors in relation to their distance a from the distal end of the training extremity is plotted along the x-axis. It is possible to identify that therapist 3 (FIG. 5) lies above or below the intended value band in the region of sensors S1, S2 and S3, while the remaining sensors lie within the band. In the case of therapist 8 (FIG. 6), only two sensors lie within the intended value band, while the remaining values lie above it.

In the case of therapist 12, the pressure values of most sensors lie to an extreme extent above the intended value band.

These measurements carried out using schooled therapists highlight the urgent need for better schooling and training of therapists in relation to the application of compression bandages; this is realized by the device according to the invention.

1. A device for training the application of compression material, with a training extremity made of hard material, at least three pressure measuring sensors, the sensor area of which lies substantially at the level of the surface of the training extremity, with a layer made of flexible padding material, which is applied over the training extremity and over the sensor areas of the pressure measuring sensors, and with a display device, which displays the pressure values measured by the pressure measuring sensors.

2. The device of claim 1, wherein the padding material consists of nonwoven or filter fabric.

3. The device of claim 1, wherein an outer surface layer, made of material that can be cleaned and disinfected, is applied over the layer made of padding material.

4. The device of claim 3, wherein the outer surface layer consists of chlorinated rubber that can be cleaned and disinfected.

5. The device of claim 1, wherein the training extremity has a hollow interior and in that metrological connections of the pressure measuring sensors are arranged in the interior of the training extremity.

6. The device of claim 1, wherein the sensor areas of the pressure measuring sensors lie at most 1 to 2 mm above the level of the training extremity.

7. The device of claim 1, wherein the pressure measuring sensors have pressure/voltage transducers, which are arranged between the pressure measuring area and a base, wherein the pressure/voltage transducer has a spherical cap-shaped sensor area, which engages into a matched recess in the pressure measuring area or in an adjustment disk.

8. The device of claim 7, wherein the pressure measuring area and the base are tensioned against one another by springs.

9. The device of claim 5, wherein all pressure measuring sensors can be connected to the metrological connections by plug/socket connections.

10. The device of claim 1, wherein the training extremity has a holding apparatus with a pivot mechanism that can be locked.

11. The device of claim 1, wherein measurement values from the pressure measuring sensors are displayed on the display device in real time.

12. The device of claim 1, wherein reference values for pressures from the pressure measuring sensors are stored in a computer, in that the measured pressure values from the pressure measuring sensors are compared to the reference values and in that deviations between the measurement values and the reference values are signaled on the display device.

13. The device of claim 12, wherein the deviations between the measurement values and the reference values are signaled by a depiction in color, in particular using the colors red, yellow and green.
